(19) United States
(12) Patent Application Publication
(10) Pub. No.: US 2026/0167844 A1
(43) Pub. Date: Jun. 18, 2026

(54) SYNTHESIS OF LOW-TOXICITY ENAMELS AND USES THEREOF

(71) Applicant: Magnekon, S.A. de C.V., San Nicolás de Los Garza (MX)

(72) Inventors: Juan Carlos MORALES HUERTA, San Nicolás de Los Garza (MX); Edgar Alberto DUARTE PEÑA, San Nicolás de Los Garza (MX); Francisco DÍAZ CAMACHO, San Nicolás de Los Garza (MX)

(73) Assignee: Magnekon, S.A. de C.V., San Nicolás de Los Garza (MX)

(21) Appl. No.: 19/097,501

(22) Filed: Apr. 1, 2025

(30) Foreign Application Priority Data
Dec. 18, 2024 (MX) MX/A/2024/016096

(51) Int. Cl. C09D 179/02; C09D 123/06; H01B 3/30

(52) U.S. Cl. CPC C09D 179/02; C09D 123/06; H01B 3/30

(57) ABSTRACT

An enamel that minimizes the emission of harmful gases during its manufacturing process, without compromising its essential properties for industrial applications, especially in the magnet wire industry. The present invention is directed to solving the technical problems identified in the state of the art, related to the risks to the health of the operators and the environmental impact derived from the release of compounds such as carbon monoxide, formaldehyde, volatile organic compounds, and diisocyanates in the synthesis of enamels. Through the advanced formulation of materials and the use of less toxic solvents, the invention seeks to provide a safer and more efficient alternative in terms of enamel manufacturing.

### CROSS-REFERENCE TO RELATED APPLICATIONS

This application claims priority from Mexican Application No. MX/a/2024/016096, filed on Dec. 18, 2024, which application is hereby incorporated in its entirety by reference in this application.

### FIELD OF THE INVENTION

The present invention generally relates to a system and method for the synthesis and application of enamels on magnet wires, based on the use of specific formulations to minimize the emission of harmful gases during the synthesis process.

### BACKGROUND OF THE INVENTION

In the field of synthesizing enamels used in industrial applications, particularly in the enameling of magnet wires, the processes currently employed face significant challenges that compromise both the health of the operators and the integrity of the environment. These problems primarily arise from the generation of residual byproducts during synthesis, such as carbon monoxide, formaldehyde, volatile organic compounds (VOCs) and diisocyanates. These byproducts, due to their toxic and highly volatile nature, represent a direct risk to the people involved in the manufacturing stages, as prolonged or cumulative exposure may lead to respiratory diseases, skin irritations, and, in more severe cases, systemic complications affecting vital organs.

Additionally, the emission of these compounds not only has repercussions on human health but also causes considerable environmental impact. The release of toxic gases into the environment contributes significantly to atmospheric pollution, aggravating global issues such as global warming and the degradation of air quality. This scenario is particularly concerning in industrial contexts where the production volume is high, amplifying the quantity of emitted pollutants and the risks associated with the improper handling of chemical wastes.

Despite advances in enamel synthesis technology, current methods have not effectively prioritized the reduction of these dangerous byproducts. On the contrary, conventional processes persist in the use of traditional solvents such as cresol, phenol and xylenols, which, although effective in fulfilling the functional properties of the enamel, are highly volatile and represent critical risks to health and the environment. The handling of these compounds involves not only direct exposure to dangerous substances, but also the need to implement rigorous safety measures, such as advanced ventilation systems and the use of personal protective equipment, which significantly increases operating costs.

This situation evidences an important gap in the development of safer and more sustainable technologies. Although isolated efforts have been made to optimize certain aspects of the synthesis process, most proposals in the state of the art do not comprehensively address the issues associated with the emission of harmful byproducts. Consequently, there remains an urgent need for solutions that not only maintain the desired properties in enamels, such as adhesion, electrical resistance and flexibility, but also minimize risks to workers and reduce environmental impact, moving toward more responsible and sustainable industrial practices.

Within the state of the art, technologies aimed at solving the previously mentioned technical problem are known; such is the case of Chinese Patent Application CN105778733B, published on Jul. 20, 2016, which describes a method for preparing an eco-friendly, phenol-free polyester type wire enamel. In a first step, an eco-friendly mixed solvent is prepared, composed of four components: a high boiling point solvent (plutonium carbonate), a mid-high boiling point solvent (dicarboxylic acid diester), a mid-low boiling point solvent (diester oxalate or biscarbonate), and an aromatic diluent (dimethylbenzene). The proportions are 1-2 parts of the high boiling point solvent, 1-3 parts of the mid-high boiling point solvent, 1-3 parts of the mid-low boiling point solvent, and 1-2 parts of the aromatic diluent.

In a second step, the CN '733 method contemplates preparing the hydroxylated resin using aromatic acid, polyhydric alcohol, and ethylene glycol in proportions of 3-6:1.5-4:0.8-3, and performs an initial esterification followed by a polycondensation reaction with a catalyst (tin octoate). The reaction is carried out at a temperature of 100-200° C. for 1-2 hours, followed by reflux at 210±10° C. for 2-4 hours, eliminating water and excess ethylene glycol. Subsequently, dimethylbenzene is extracted at 200° C. and 0.01-0.09 MPa for 10-40 minutes to obtain the hydroxylated resin.

Subsequently, in a third step, the hydroxylated resin solution is prepared by mixing the resin with the eco-friendly mixed solvent in proportions of 4-6:5-7. The mixture is cooled to room temperature to obtain the hydroxylated resin solution, and in a fourth step, the phenol-free polyester wire enamel is prepared by mixing the hydroxylated resin solution with the mixed solvent in proportions of 1-3:0.1-2, adding butyl titanate (0.2-1% of the total liquid weight). The mixture is agitated at 30-80° C. for 0.5-2 hours and then filtered to remove impurities. The technical specifications of the prepared hydroxylated resin are an acid number of 0.1-2 mgKOH/g, a hydroxyl value of 130-280 mgKOH/g, an average molecular weight of 4500-6500 Daltons, and a molecular weight distribution index of 1.9-2.3.

On the other hand, the polyester wire enamel exhibits a solid content of 25-50%, a viscosity of 20-80 seconds (at 25° C.) and an appearance of a transparent viscous liquid ranging in color from white to pale yellow.

Thus, CN '733 seeks to eliminate the use of phenol, reducing corrosiveness, unpleasant odors and improving quality stability. Additionally, it substitutes dimethyl terephthalate with the more economical phthalic acid and uses tin octoate as a catalyst, which reduces costs and production time. The resulting enamel is compatible with current painting equipment and techniques, providing high dielectric strength (over 180° C.) and minimizing defects in the enameled wire.

Furthermore, Japanese Patent Application JPH11224536A, published on Aug. 17, 1999, discloses a polyimide-amide enameled wire that can be soldered to a conductor without the need to remove the enamel layer. The main objective is to provide a wire that combines solderability with a high softening temperature. Specifically, JP '536 aims to provide a polyimide-amide enameled wire that offers high solderability and a high softening temperature, overcoming the limitations of the wires mentioned in the state of the art. The composition of the enamel of JP '536 is based on a polyimide-amide resin obtained by the reaction of a diisocyanate with a carboxylic anhydride. The diisocyanate component must contain at least 20% molar of alicyclic diisocyanate to ensure solderability. Certain alicyclic and aromatic diisocyanates are preferred, as well as trimellitic anhydride as the carboxylic anhydride. The reaction between the diisocyanate and the carboxylic anhydride is carried out in a polar solvent, such as N-methylpyrrolidone or dimethylacetamide. The enameled wire is obtained by applying the polyimide-amide resin paint onto a conductor and baking it at high temperature. The resulting enameled wire from JP '536 can be soldered directly without the need to remove the enamel layer, also offering high thermal resistance and an elevated softening temperature, surpassing the specifications of existing solderable wires.

Additionally, within the state of the art is known U.S. Pat. No. 10,781,341B2, published on Aug. 6, 2015, which discloses a polyamide polymer derived from the reaction of: at least one diamine of Structure (Ia) or (Ib), at least one diamine of Structure (II), at least one tetracarboxylic acid dianhydride, and a compound with a first functional group reactive with an amine or an anhydride and a second functional group selected from substituted or unsubstituted linear alkenyl and substituted or unsubstituted linear alkynyl. Examples of diamines of these structures include specific compounds such as 1-(4-aminophenyl)-1,3,3-trimethylindan-5-amine. The polyamide polymer may be synthesized using various additional diamines with structures such as H₂N—X₃—NH₂, where X₃ is a divalent organic group. The reaction of these components with suitable tetracarboxylic acid dianhydrides produces a polyamic acid, which can be imidized thermally or chemically to form a polyamide polymer. Thermal imidization can be carried out in the solid state or in solution at temperatures between 100° C. and 400° C., while chemical imidization uses dehydrating agents and non-nucleophilic bases under specific conditions. This imidization is confirmed by characteristic absorptions in the infrared spectrum.

Derived from the teachings of the state of the art, it is clear that, to date, the synthesis processes of enamels used in the wire enameling industry generate a significant amount of harmful gases and byproducts, such as carbon monoxide, formaldehyde, volatile organic compounds (VOCs) and diisocyanates. These compounds not only pose a risk to the health of the operators involved, who are constantly exposed to these contaminants, but also have a negative impact on the environment due to their high volatility and toxicity. Currently, no effective solution has been found that comprehensively addresses the reduction of these harmful gases during the enamel synthesis process. The known methods have not prioritized mitigating the generation of these byproducts, demonstrating the urgent need for a process that minimizes the risks to human health and the environment while preserving or even improving the properties of the enamels, such as adhesion, viscosity, flexibility and electrical resistance.

Therefore, there is a technical need to develop an enamel synthesis process that utilizes alternative formulations and solvents that not only reduce or eliminate the emission of these harmful compounds, but also ensure a quality and functionality comparable or superior to those of enamels produced with current technologies. This approach is crucial for the industry, as it not only improves working conditions by protecting the health of the operators, but also significantly contributes to environmental sustainability.

### SUMMARY OF THE INVENTION

It is, therefore, an objective of the present invention to provide a comprehensive and efficient solution for the synthesis of enamels that significantly minimizes the generation of harmful gases and byproducts during the manufacturing process.

In particular, the invention seeks to solve the technical problems arising from the presence of dangerous compounds such as carbon monoxide, formaldehyde, volatile organic compounds (VOCs) and diisocyanates, which are known for their negative effects on both the health of the involved operators and the environmental impact. These compounds, generated during the chemical reaction, not only pose risks to workers due to their high toxicity and volatility, but also contribute to environmental degradation, making the need for a solution that reduces or eliminates their presence in the enamel synthesis process urgent.

Based on the above, a general objective of the invention is to provide a methodology for the synthesis of enamels that uses formulations based on polyester, polyesterimide and polyamideimide, combined with specific solvents such as propylene carbonate and 3-methoxy-N,N-dimethylpropanamide. This combination has been designed to ensure that the enamel synthesis process generates a minimal, or even zero, amount of toxic gases or dangerous byproducts. The invention seeks not only to mitigate the risks to the health of the operators, but also to significantly reduce the environmental impact of the wire enameling industry. At the same time, the key properties of the enamels, such as adhesion, viscosity, flexibility and electrical resistance, are maintained or even improved, ensuring the quality and functionality of the resulting products.

A particular objective of the present invention is to provide an innovative procedure that, through the use of these specific formulations, achieves a considerable decrease in harmful byproducts compared to traditional processes. The enamels obtained through this process not only have a lower emission of dangerous compounds, but also maintain the physical properties necessary for their application in critical industrial products such as motors and transformers. This approach allows for a safer process for the operators, while meeting environmental standards by reducing the emissions of harmful volatile compounds.

Another particular objective of the invention is to provide a procedure for the application of the resulting enamel on magnet wires, ensuring that the coating is uniform and that the adhesion is adequate for its use in critical components. To this end, the invention proposes the use of specific co-solvents, in particular dibasic esters, which facilitate the processability of the enamel during its application. This system ensures that the enamel adheres effectively to the magnet wires, which is crucial to guarantee the quality and performance of the final product. Furthermore, by using these co-solvents, the application process is optimized without compromising safety, minimizing exposure to volatile and toxic compounds for the operators.

Another particular objective of the invention is to obtain a high solids enamel (above 60%) with suitable viscosity (below 4000 cP) for processing in enameling machines, which has the advantage of considerably reducing emissions to the environment by having a lower amount of solvents than traditional enamels; in addition to a technical advantage since with a higher solids content, the number of steps in an enameling machine is reduced, thereby improving the efficiency of the enameling process.

### BRIEF DESCRIPTION OF THE DRAWINGS

FIG. 1 shows an example of the synthesis of a PE enamel that uses solvents free of cresol and its subsequent adjustment with different green solvents, where the different solvent compatibilities with the enamel are observed.

FIG. 2 shows a comparison between weight molecular weights (Mw) and numbers (Mn) of PE and PEI enamels using different solvents, where it is observed that the molecular weight of those free of cresol is similar to those obtained with green solvents.

FIG. 3 illustrates comparisons between the viscosity and the percentage of solids of PE and PEI enamels using cresol and green solvents free of cresol. It can be observed that when using green solvents, viscosities lower than those obtained when cresol is used as the solvent are achieved, so by using this type of solvent, it is possible to increase the percentage of solids, which favors processing in enameling.

FIG. 4 shows a graph obtained by DSC at 20° C./min under a N₂ atmosphere, in which a comparison of thermograms between the glass transition temperature (Tg) of the solids obtained at 1 g, 1 h at 180° C. of the enamels obtained both by cresol and by green solvents is observed. Emphasis is placed on the fact that the Tg was the same in both cases, which allows the conclusion that the change to a green solvent does not affect one of the main properties of the polymer contained in the enamel.

FIG. 5 shows a graph in which a comparison by Fourier Transform Infrared Spectroscopy (FTIR) is observed, and a comparison of spectra of the solids obtained at 1 g, 1 h at 180° C. of the enamels obtained both by cresol and by green solvents is presented. Emphasis is placed on the fact that the spectra have a correlation of 99.1%, which allows the conclusion that the change to a green solvent does not affect the distribution of functional groups of the enamel polymer.

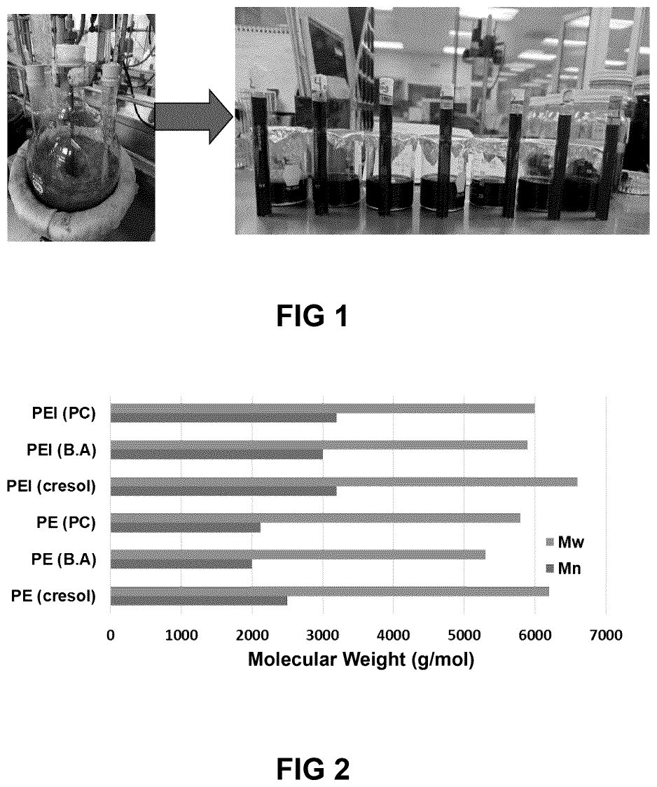

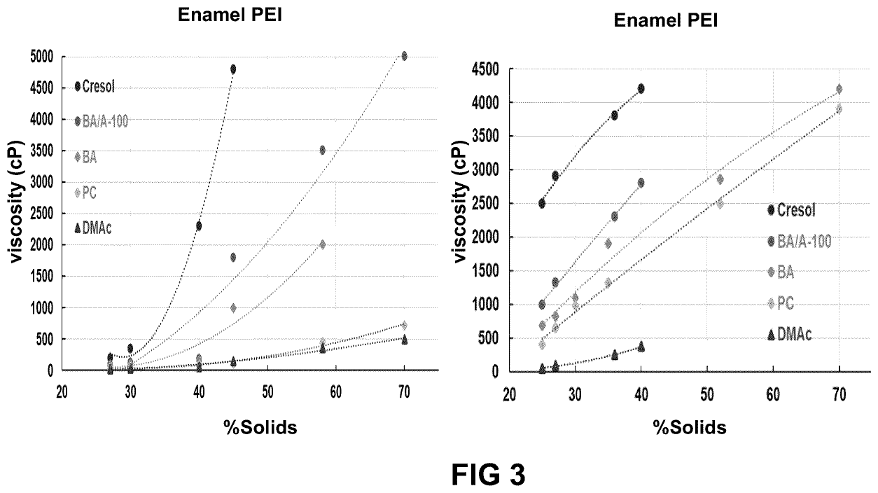

### DETAILED DESCRIPTION OF THE INVENTION

Some aspects of the present invention will now be described in greater detail using reference to the accompanying drawings, in which some embodiments and advantages of the present invention are shown. For a person skilled in the art, it will be evident that several embodiments of the invention may be expressed in different forms and should not be interpreted as limited to the embodiments here described; rather, these exemplary embodiments are provided so that this invention is clear and complete, and fully conveys the scope of the invention to experts in the field. For example, unless otherwise indicated, something described as first, second or similar should not be interpreted as a particular order.

As used in the description and in the appended claims, the singular forms “a, an”, “the” include plural references unless the context clearly indicates otherwise. The different aspects of the present invention relate to an enamel whose purpose is to minimize the emission of harmful gases during its manufacturing process, without compromising its essential properties for industrial applications, especially in the magnet wire industry.

The present invention is aimed at solving the technical problems identified in the state of the art, related to the risks to the health of the operators and the environmental impact derived from the release of compounds such as carbon monoxide, formaldehyde, volatile organic compounds and diisocyanates in the synthesis of enamels.

Through the advanced formulation of materials and the use of less toxic solvents, the invention seeks to provide a safer and more efficient alternative in terms of enamel manufacturing.

Therefore, according to one embodiment, the present invention comprises an enamel composed of:
A) At least one polymer, to achieve an optimal balance between durability, flexibility, and thermal resistance in the resulting enamel of the present invention. In particular, the at least one polymer is selected not only for its adhesion and mechanical resistance properties, but also because it facilitates a safer enamel synthesis process by reducing the release of toxic compounds. Additionally, the at least one polymer according to the present invention is characterized by its high chemical and thermal resistance, making it ideal for industrial applications where the enamel must withstand extreme conditions, such as high temperatures or exposure to chemicals, in addition to providing abrasion resistance, flexibility, and thermal resistance of the enamel. In one particular embodiment, the at least one polymer is any polymer selected from the group comprising polyester, polyesterimide, PEI (polyetherimide), PPS (polyphenylsulfide), PPO (polyphenylene oxide), polyurethane and polyamideimide, combinations thereof and/or similar. In one embodiment, the at least one polymer is a mixture of polyester, polyesterimide, polyurethane and polyamideimide. Now, depending on the desired viscosity and the final flexibility of the enamel, variants of polyester with different degrees of polymerization may be used. In some embodiments, the at least one polymer is mixed and combined with resins or materials to achieve greater hardness or solvent resistance. In that embodiment, the resins or materials that allow for greater hardness or resistance are any selected from the group comprising epoxy resins, phenolic resins, unsaturated polyesters, ureas, melamines and silicones, combinations thereof and/or similar; as for materials, these are any selected from the group comprising glass and carbon fibers, clay particles, carbon nanotubes and micofillers such as talc or kaolin, combinations thereof and/or similar. In one embodiment, the at least one polymer is present in a range from 30 to 70% by weight of the enamel with a viscosity suitable for its processing. These polymers are highly resistant to temperature changes and exposure to chemicals, making the resulting enamel ideal for use in motors, transformers, and other industrial components that require exceptional mechanical and electrical properties.
B) At least one solvent; which significantly reduces the emission of harmful gases during the manufacturing of the enamel, eliminating compounds such as carbon monoxide, formaldehyde and other volatile organic compounds that are dangerous to human health and the environment. In one embodiment, the at least one solvent is any selected from the group comprising carbonates such as propylene carbonate, ethylene carbonate, diethyl carbonate, dimethyl carbonate, butylene carbonate, combinations thereof and/or similar; also comprising amides, such as 3-methoxy-N,N-dimethylpropanamide; N-methyl-2-pyrrolidone (NMP), dimethylacetamide (DMAc), tetramethylurea, ethylene glycol esters, tetrahydrofuran (THF), 1,4-dioxane and other sulfoxides, combinations thereof and/or similar. In one embodiment, the at least one solvent is a low-toxicity solvent; in that embodiment, the at least one solvent is an organic solvent of low environmental impact; more particularly, in one embodiment, the low-toxicity solvent is any selected from the group comprising cyclic ethers such as tetrahydrofuran and 1,4-dioxane, esters such as ethyl acetate and butyl esters, ketones such as acetone and methyl isobutyl ketone, aliphatic hydrocarbons such as hexane and heptane, aromatic hydrocarbons such as toluene and xylene, and alcohols such as ethanol and isopropanol, combinations thereof and/or similar. Additionally, in one embodiment, the at least one solvent is present in a range from 20% to 60% of the enamel with a viscosity suitable for its processing.

The present invention further comprises a method for the preparation of the enamel which proposes a series of detailed steps that allow for carefully controlling emissions and improving the properties of the final product.

The method of the present invention, according to one embodiment, comprises the following steps:

### i) Prepare the Base Mixture of the Enamel

This initial step aims to uniformly mix the at least one polymer and the at least one solvent previously mentioned in the present application, ensuring that all ingredients are adequately incorporated before the chemical reaction process begins.

In this stage, in the selected embodiment, the at least one polymer (or the mixture of polymers which, according to a preferred embodiment, is a mixture of polyester, polyesterimide, polyurethane and polyamideimide) is combined with the at least one solvent.

In this embodiment, a homogeneous mixture is ensured to guarantee consistent enamel quality, where temperature and agitation conditions are controlled to avoid the formation of bubbles or inconsistencies in the mixture.

In one embodiment, the mixture is carried out in cold conditions or using heat, with such condition being controlled to favor the dissolution of the more resistant polymers and ensuring the integrity of the enamel, avoiding the formation of impurities or undesired materials that may alter the final properties of the product.

ii) Control the Temperature and Agitation of the Mixture from Step i)

In one embodiment, within this step, the viscosity and distribution of the components are optimized, so that the enamel has a consistency suitable for its application, and it is ensured that the solvents evaporate in the correct proportions. In particular, the temperature of the mixture is controlled and precise agitation is applied to ensure the complete dissolution of all ingredients, which also allows adjusting the viscosity to facilitate the application of the resulting enamel on metallic substrates.

In one embodiment, the temperature used is in a range from 80 to 150° C.

In one embodiment, the agitation speed is adjusted to optimize the mixture without introducing air, which can cause undesired bubbles. In that embodiment, the agitation speed is within a range from 300 to 1000 rpm.

Also, in one embodiment, high-speed agitators or low-speed mixers are used.

iii) Reduce Emissions of Harmful Byproducts

In one embodiment, the proposed invention comprises the step of reducing the emission of dangerous gases generated during the manufacturing of the enamel to ensure that the process is safe for the operators and the environment.

During this step, in the described embodiment, measures are applied to control the temperature and pressure in the mixture, which allows reducing the release of harmful volatile compounds.

In one embodiment, the temperature used is in a range from 180 to 240° C.

On the other hand, according to one embodiment, the pressure used in this step is in a range from 10 to 150 atm.

In an optional embodiment, the step involves the use of gas recovery systems, that is, filtering or gas capture systems to conduct the harmful byproducts—which, although reduced based on the method of the present invention—that might be generated.

### iv) Perform an Enamel Synthesis

In one embodiment, the proposed invention comprises the step of performing an enamel synthesis under controlled conditions to guarantee the quality and reproducibility of the final product.

During this step, in the described embodiment, high-purity raw materials are used and the proportions of the components are adjusted to obtain the desired characteristics in the enamel.

In one embodiment, the synthesis of PE enamels is carried out, wherein, in a reactor with N₂, the green solvent (Alcohol, Benzyl (BA), Ethylene Carbonate (EC), Propylene Carbonate (PC) or Levoglucosanone) is added in a proportion of 5 to 15% by weight and a diol such as 1,4-ethanediol (EG), 1,3-propanediol (PD) or 1,4-butanediol (BD) in a proportion of 5 to 10%, an aromatic dicarboxylic acid, such as phthalic acid, terephthalic acid, isophthalic acid, etc., in a proportion of 15 to 30%, an aromatic triol, such as Tris(2-hydroxyethylisocyanurate) (THEIC), etc., in a proportion of 15 to 30%. An organometallic catalyst such as Tert-butyl titanate (TBT), Tin Octoate (Sn(Oct)₂), among others, is used.

In one embodiment, the reaction is carried out at a temperature between 18° and 230° C. with reflux for 8 to 10 h. Once this temperature is reached, the reaction is stopped by lowering the temperature and adding the green solvents and flow, antifoam, and adhesion additives.

Additionally, in one embodiment, adjustments are made with the green solvent system to reach the desired solids and viscosity, which are in a range of 40 to 80% and 400 to 4000 cP, respectively. In one embodiment, the additives, the flow, antifoam and adhesion additives are selected from the group comprising polyethers of polysiloxanes, silicone glycol copolymers, and extenders. In another embodiment, the synthesis of PEI enamels is performed, wherein, in a reactor with N₂, the green solvent (Alcohol, Benzyl (BA), Ethylene Carbonate (EC), Propylene Carbonate (PC), Levoglucosanone) is added in a proportion of 5 to 15% by weight and a diol such as 1,4-ethanediol (EG), 1,3-propanediol (PD) or 1,4-butanediol (BD) in a proportion of 5 to 10%, an aromatic diester, such as dimethyl terephthalate (DMT), terephthalic acid, isophthalic acid, dimethyl isophthalate, etc., in a proportion of 2 to 10%, compounds derived from aniline, such as 4,4-methylene dianiline (MDA), hexamethylenediamine, etc., in a proportion of 5 to 15%, an aromatic triol, such as Tris(2-hydroxyethylisocyanurate) (THEIC), trimethylolpropane, etc., in a proportion of 15 to 30%. An organometallic catalyst such as Tert-butyl titanate (TBT), Tin Octoate (Sn(Oct)₂), among others, is used. The reaction is carried out at a temperature between 15° and 200° C. with reflux for 3 to 6 h. Once this temperature is reached, the reaction is stopped by lowering the temperature and adding the green solvents and flow, antifoam, and adhesion additives. It is adjusted with a green solvent system to the desired solids and viscosity, which range from 25 to 70% solids and a viscosity of 400 to 4100 cP.

### v) Apply the Enamel on Magnet Wires

Once the synthesis is completed (according to the previous step), in one embodiment the enamel is applied on, for example but not limited to, magnet wires, ensuring—derived from the different components and the conditions according to the different embodiments of the present invention—that the coating is uniform and resistant to usage conditions.

In that embodiment, the enamel is applied using appropriate techniques to ensure a uniform layer on the wires.

In one embodiment, specific co-solvents are used to guarantee good adhesion and coverage of the enamel; in that embodiment, the co-solvents are any selected from the group comprising water and alcohols; organic solvents such as, but not limited to, hexane and ethyl acetate, toluene and methanol, dichloromethane, methanol combination thereof and/or similar; polar and non-polar solvents such as, but not limited to, water and acetone, water and THF (tetrahydrofuran), combination thereof and/or similar; halogenated and aliphatic solvents such as, but not limited to, dichloromethane and hexane, chloroform and pentane, combinations thereof and/or similar; mixtures of water with glycols (ethylene glycol, propylene glycol), combination thereof and/or similar.

On the other hand, according to one embodiment, the application of the resulting enamel according to the present invention is performed through immersion and/or spraying and/or brushing.

### Examples

In a reactor with N₂, the green solvent (Alcohol, Benzyl (BA), Ethylene Carbonate (EC), Propylene Carbonate (PC), Levoglucosanone) is added in a proportion of 5 to 15% by weight and a diol such as 1,4-ethanediol (EG), 1,3-propanediol (PD) or 1,4-butanediol (BD) in a proportion of 5 to 10%, an aromatic dicarboxylic acid, such as phthalic acid, terephthalic acid, isophthalic acid, etc., in a proportion of 15 to 30%, an aromatic triol, such as Tris(2-hydroxyethylisocyanurate) (THEIC), etc., in a proportion of 15 to 30%. An organometallic catalyst such as Tert-butyl titanate (TBT), Tin Octoate (Sn(Oct)₂), among others, is used. The reaction is carried out at a temperature between 18° and 230° C. with reflux for 8 to 10 h. Once this temperature is reached, the reaction is stopped by lowering the temperature and adding the green solvents and flow, antifoam, and adhesion additives. Adjustments are made with the green solvent system to achieve the desired solids and viscosity, which are in a range of 40 to 80% and 400 to 4000 cP respectively.

Compatibility tests of solvents and solubility tests of the resin were performed, observing which of them were compatible and aiming to meet properties such as viscosity and evaporation profile. FIG. 2 illustrates a table where the solubility with the different solvents can be observed; likewise, Table 1 shown below practically summarizes the results obtained:

TABLE 1

Resin

| Solvent | PE | PEI |
|---|---|---|
| Naphthas | −− | − |
| Alkylbenzenes | −− | − |
| Benzyl Alcohol | ++ | ++ |
| DMAc | ++ | ++ |
| PC | ++ | ++ |
| EC | ++ | + |
| Cresol | ++ | ++ |

++ very soluble
+ soluble
− slightly soluble
−− very slightly soluble

The results show that, among the most common green solvents, such as PC, EC and Benzyl Alcohol, there is good solubility, while in others that, in combination with others of petroleum origin, such as Naphthas and Alkylbenzenes, there is some difficulty in dissolving.

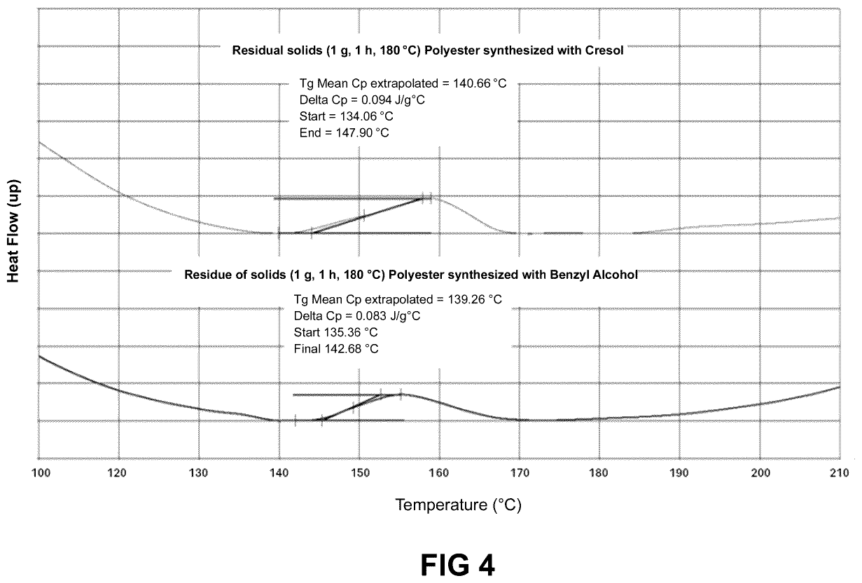

Furthermore, as shown in FIG. 4, a comparison of the glass transition temperature (Tg) of the solids obtained at 1 g, 1 h at 180° C. of a polyester enamel synthesized with a solvent with cresol and one free of cresol was performed. In both cases, the Tg was very similar since, in the case of the enamel synthesized with cresol, it was 140° C. and in the case of the one synthesized with Benzyl Alcohol it was 139° C., which indicates that they practically have the same Tg and indicates that the polymer obtained after curing was the same.

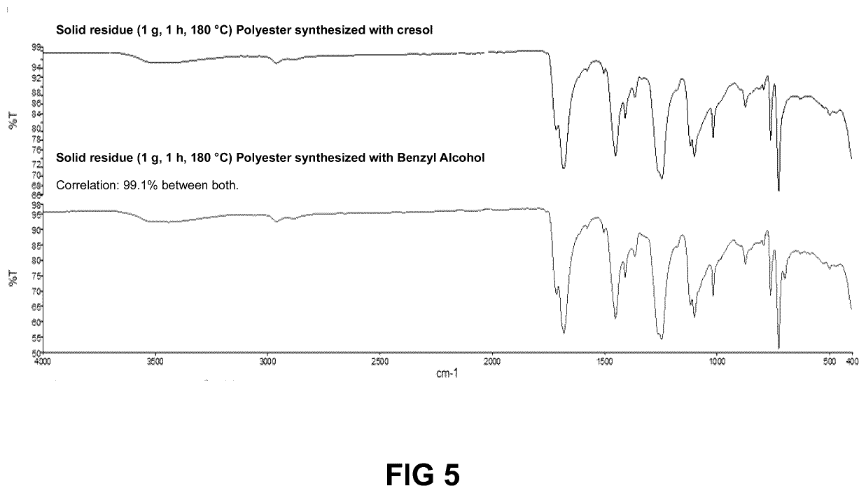

In order to compare whether a similar chemical structure in the polymer is obtained using both cresol and organic solvents, it was decided to perform infrared tests on the solids obtained from the Non-Volatiles test (1 g, 1 h, 180° C.). The FTIR results, as illustrated in FIG. 5, show that the spectrum has a correlation of 99.1%, which confirms that the chemical structure of the polymer is similar after curing.

In addition to the previous characterization, a study of molecular weights was carried out using the GPC technique. The results are shown in Table 2 below:

TABLE 2

| | Mn (g/mol) | Mw (g/mol) | Polydispersity |
|---|---|---|---|
| PE (cresol) | 2500 | 6200 | 2.48 |
| PE (B.A) | 2000 | 5300 | 2.65 |
| PE (PC) | 2120 | 5800 | 2.74 |
| PEI (cresol) | 3200 | 6600 | 2.06 |
| PEI (B.A) | 3000 | 5900 | 1.97 |
| PEI (PC) | 3200 | 6000 | 1.88 |

It is observed that the molecular weights of those produced with green solvents and those produced with cresol are similar; even the polymers that are produced with a green solvent have a lower polydispersity, which represents an important advantage since it indicates that a lower variation in the polymer chains was obtained; which in turn means an improvement in the properties.

With these results, it can be concluded that, as for the polymer, the material synthesized in one way or another is similar; therefore, its mechanical properties are equal with the advantage that this new proposal is carried out with environmentally friendly solvents. On the other hand, regarding the solvent system, the level of solvation is higher in the case of green solvents, which allows meeting the objective of obtaining an enamel with suitable viscosity and high solids.

Many modifications and other embodiments of the invention will come to the mind of an expert in the field to which the invention belongs, who benefits from the teachings presented in the preceding descriptions and the associated drawings. Therefore, it should be understood that the invention should not be limited to the specific and exemplary embodiments described, but that modifications and other embodiments are intended to be included within the scope of the appended claims. Although specific terms are used herein, they are used only in a generic and descriptive sense and not for limiting purposes. Likewise, it should be understood that the materials with which the various components of the invention described in this document can be manufactured, the geometries, dimensions, arrangements, and other elements may vary without departing from the scope and spirit of the invention and, therefore, the referred embodiments should not be considered limiting.

1. A method for synthesizing a low-toxicity enamel, comprising an enamel comprising at least one polymer and at least one solvent; the method comprising the steps of:
(i) mixing the at least one polymer and the at least one solvent;
(ii) agitating the mixture from step (i) at a constant speed, pressure, and temperature;
(iii) extracting generated gas emissions; and
(iv) synthesizing the mixture,
wherein,
the synthesis for PE enamels is carried out in a reactor with N₂ and a green solvent is added in a proportion of 5 to 15% by weight and a diol in a proportion of 5 to 10%, an aromatic dicarboxylic acid in a proportion of 15 to 30%, an aromatic triol in a proportion of 15 to 30%, and an organometallic catalyst, and the reaction is carried out at a temperature between 18° and 230° C. under reflux for 8 to 10 h; subsequently, the green solvents along with flow additives, antifoam, and adhesion additives are added; and
the synthesis for PEI enamels is carried out in a reactor with N₂ and a green solvent is added in a proportion of 5 to 15% by weight, the diol in a proportion of 5 to 10%, an aromatic diester in a proportion of 2 to 10%, aniline-derived compounds in a proportion of 5 to 15%, the aromatic triol in a proportion of 15 to 30%, and the organometallic catalyst; the reaction is carried out at a temperature between 15° and 200° C. under reflux for 3 to 6 h; subsequently, the green solvents and flow, antifoam, and adhesion additives are added, and the amount of solids and viscosity are adjusted to a range of 25 to 70% solids and 400 to 4100 cP viscosity.

2. The method according to claim 1, wherein the mixture of the at least one polymer and the at least one solvent is incorporated prior to the initiation of the chemical reaction process.

3. The method according to claim 1, wherein the mixture is a homogeneous mixture.

4. The method according to claim 1, wherein the mixture is carried out under cold conditions or with applied heat.

5. The method according to claim 1, wherein the mixture is carried out at a constant agitation speed using high-speed agitators or low-speed mixers.

6. The method according to claim 1, wherein the pressure of the mixture is in a range from 10 to 150 atm.

7. The method according to claim 1, wherein the extraction of generated gas emissions is carried out through gas filtering or capture systems to channel the harmful byproducts.

8. The method according to claim 1, wherein the green solvent is any selected from the group comprising Alcohol, Benzyl (BA), Ethylene Carbonate (EC), Propylene Carbonate (PC), or Levoglucosanone, and wherein the viscosity is in a range of 40 to 80% and 400 to 4000 cP.

9. The method according to claim 1, wherein the diol is selected from the group comprising 1,4-ethanediol (EG), 1,3-propanediol (PD), or 1,4-butanediol (BD).

10. The method according to claim 1, wherein the aromatic dicarboxylic acid is any selected from the group comprising phthalic acid, terephthalic acid, or isophthalic acid.

11. The method according to claim 1, wherein the aromatic triol is Tris(2-hydroxyethylisocyanurate) (THEIC).

12. The method according to claim 1, wherein the organometallic catalyst is selected from the group comprising Tert-butyl titanate (TBT) or Tin Octoate (Sn(Oct)₂).

13. The method according to claim 1, wherein the flow, antifoam, and adhesion additives are polyethers of polysiloxanes, silicone glycol copolymers, and extenders.

14. The method according to claim 1, wherein the aromatic diester is any selected from the group comprising dimethyl terephthalate (DMT), terephthalic acid, isophthalic acid, or dimethyl isophthalate.

15. The method according to claim 1, wherein the aniline-derived compounds are any selected from the group comprising 4,4-methylene dianiline (MDA) or hexamethylenediamine.

16. The method according to claim 1, wherein the at least one polymer within the enamel composition is in a range from 30% to 70%.

17. The method according to claim 1, wherein the at least one solvent within the enamel composition is in a range from 20% to 60%.

18. The method according to claim 4, wherein the mixture is carried out at a temperature in a range from 80 to 150° C.

19. The method according to claim 5, wherein the agitation speed is in a range from 300 to 1000 rpm.

20. A magnet wire, characterized in that it is coated with the enamel according to claim 1.

21. The magnet wire according to claim 20, wherein the coating is uniform over the entire surface of the magnet wire and the coating is applied through any selected from the group comprising immersion, spraying, misting, brush application, or a combination thereof.

22. The magnet wire according to claim 20, wherein co-solvents are used to adhere and cover the magnet wire.

23. The magnet wire according to claim 22, wherein the co-solvents are any selected from the group comprising water and alcohols; organic solvents such as, but not limited to, hexane and ethyl acetate, toluene and methanol, dichloromethane, methanol combination thereof and/or similar; polar and non-polar solvents such as, but not limited to, water and acetone, water and THF (tetrahydrofuran), combination thereof and/or similar; halogenated and aliphatic solvents such as, but not limited to, dichloromethane and hexane, chloroform and pentane, combinations thereof and/or similar; and mixtures of water with glycols (ethylene glycol, propylene glycol), combination thereof and/or similar.
